(19) United States
(12) Patent Application Publication
(10) Pub. No.: US 2026/0160028 A1
(43) Pub. Date: Jun. 11, 2026

(54) VIBRATORY PLATE COMPACTOR AND METHOD FOR ADJUSTING A TRANSPORT DEVICE OF A VIBRATORY PLATE COMPACTOR PIVOTABLE BETWEEN A STOWED POSITION AND A TRANSPORT POSITION

(71) Applicant: BOMAG GMBH, Boppard (DE)

(72) Inventor: Denis PAVOKOVIC, Boppard (DE)

(21) Appl. No.: 19/177,765

(22) Filed: Apr. 14, 2025

(30) Foreign Application Priority Data
Apr. 24, 2024 (DE) 10 2024 111 493.2

(51) Int. Cl. E01C 19/35; E01C 21/00; E02D 3/046; F16B 2/18

(52) U.S. Cl. CPC E01C 19/35; E01C 21/00; E02D 3/046; F16B 2/185

(57) ABSTRACT

A vibratory plate compactor with a transport device mounted on a superstructure wherein it can pivot about a support arm rotation axis between a stowed position and a transport position, and to a method for adjusting a transport device of a vibratory plate compactor that can be pivoted between a stowed position and a transport position.

### FIELD

The invention relates to a vibratory plate compactor and a method for adjusting a transport

device of a vibratory plate compactor which can be pivoted between a stowed position and a transport position.

### BACKGROUND

Vibratory plate compactors are machines that are used to compact an underlying ground. These machines may be hand-guided and have a hand guide device, for example in the form of a hand guide bracket. Vibratory plate compactors usually comprise one or more imbalance exciters and may, for example, move over the ground during working operation in a bouncing manner due to the vibrations generated by the imbalance exciter(s).

There may be work situations in which the vibratory plate compactor needs to be moved or transported without bouncing, for example to protect the underlying ground and/or to be able to move the vibratory plate compactor considerably faster compared to working operation of the vibratory plate compactor. It is known in the prior art to provide a transport device with a pair of wheels on the vibratory plate compactor. The transport device may be in the form of a transport trolley, as disclosed, for example, in DE 7 212 695 U, which can be hooked into a receptacle of the vibratory plate compactor for transportation purposes. Devices are also known, as disclosed, for example, in DE 10 2008 045 557 A1 and DE 84 16 280 U1, in which transport wheels are mounted on the vibratory plate compactor such that they can pivot between a stowed position and a transport position. A further alternative is disclosed in EP 1 513 985 B1, which proposes the use of transport rollers for transportation purposes, which are permanently connected to the vibratory plate compactor.

There is still room for improvement in the known solutions with transport wheels that can be pivoted on the vibratory plate compactor between a stowed position and a transport position, as the adjustment process is in some cases perceived as uncomfortable.

### SUMMARY

Against this background, the object of the invention is to provide an improved configuration of a vibratory plate compactor with a transport device that can be adjusted between a stowed position and a transport position compared to the prior art.

The object is achieved with a vibratory plate compactor and a method according to the independent claims. Preferred embodiments are cited in the dependent claims.

A generic vibratory plate compactor comprises a substructure with a ground-contacting plate, a superstructure connected to the substructure via a damping device with one or more functional devices, and a hand guide device.

The ground-contacting plate may be a base plate in particular, which has an essentially flat contact surface. In particular, the base plate may have regions adjoining this contact surface in a forward direction and a reverse direction, and in some cases also to the sides, which are bent upwards in order to prevent the vibratory plate compactor from digging itself into the ground during operation. The ground-contacting plate therefore refers to the device with which the vibratory plate compactor rests on or is in contact with the underlying ground to be compacted during operation. One or more vibration exciter devices, in particular so-called imbalance exciters, may be arranged on the ground-contacting plate. These devices may be directly driven, in particular by an electric or hydraulic motor also arranged on the ground-contacting plate, or driven by a powered drive gear, in particular a belt drive.

A so-called superstructure is mounted on top of the substructure. This superstructure is connected to the substructure via vibration damping devices, for example rubber buffers, and represents a frame-like support structure for one or more functional devices, such as a drive motor, in particular an electric motor or combustion engine, an energy storage device, such as in particular an accumulator or a fuel tank, a water tank, a control device, such as a motor control unit and/or power electronics, or similar.

Also connected to the superstructure is the hand guide device, which may be, for example, an essentially U-shaped guide bracket or a guide drawbar. To reduce HAV (hand-arm vibration) stress for an operator, the hand guide device is also preferably connected to the superstructure via a vibration damping device, which in this case may likewise involve rubber buffers or rubber mounts, for example. An operator of the vibratory plate compactor can use the hand guide device to influence the direction and/or travel speed of the vibratory plate compactor, for example to push it around a bend for cornering or similar. The hand guide device may be pivotably mounted on the superstructure. It is preferred if the hand guide device is hinged to the superstructure in a rear area of the superstructure, in particular in a rear third of the superstructure with respect to the longitudinal extension of the superstructure in a forward direction of the vibratory plate compactor. Furthermore, the manual guide device is preferably configured such that the operator can operate it manually while moving the vibratory plate compactor in a forward direction and usually walks behind the vibratory plate compactor during operation.

A transport device is also part of the vibratory plate compactor. This device may be mounted on the superstructure of the vibratory plate compactor such that it can pivot about a support arm rotation axis between a stowed position and a transport position. The transport device comprises at least one wheel arranged on a support device with at least one support arm, the at least one support arm being pivotable about the support arm rotation axis relative to the superstructure of the vibratory plate compactor together with the pair of wheels between the stowed position and the transport position. The support arm thus represents the, preferably single-membered, connecting lever between the superstructure and the at least one wheel. The wheel is preferably mounted on the support arm such that it can rotate about a rotation axis. If multiple wheels are provided, for example in the form of a pair of wheels, these are preferably arranged on the support arm such that they can rotate about parallel and/or coaxial rotation axes. Multiple support arms, in particular a pair of support arms, may also be provided, which are axially spaced along these rotation axes. It is contemplated that each support arm of the pair of support arms has an associated wheel rotatably mounted thereon. Each support arm may have more than one associated wheel. The at least one wheel, in particular multiple wheels and especially a pair of wheels, may be associated with or mounted on multiple support arms at the same time.

In the transport position, the at least one wheel, in particular the pair of wheels, is preferably in a position relative to the rest of the vibratory plate compactor in which it is located below the ground-contacting plate, so that the rest of the vibratory plate compactor can be jacked up on the at least one wheel, in particular the pair of wheels, so that it be transported more easily. This jacking up can be effected by an operator, for example, with the aid of the hand guide device, which is then used to initiate a pitching movement of the vibratory plate compactor about a transverse axis transverse to the forward direction. The vibratory plate compactor then no longer rests on the ground via the ground-contacting plate, but via the at least one wheel, in particular the pair of wheels. The ground-contacting plate may be mounted on or at the support arm(s).

In the stowed position, on the other hand, the transport device is adjusted on the vibratory plate compactor such that the at least one wheel, in particular the pair of wheels, is raised relative to the underlying ground and, ideally, is stowed as space-savingly as possible at least essentially within the outer contour of the vibratory plate compactor formed by the superstructure, the substructure and the hand guide device. It is particularly preferred if the hand guide device is configured as a hand guide bracket and the at least one wheel, in particular the pair of wheels, as well as the support arm(s), at least in the stowed position, preferably also in the transport position, lie within the width of the hand guide device when viewed in the forward direction of the vibratory plate compactor.

In particular, the transport device may be configured such that it remains mounted on the vibratory plate compactor when it is adjusted between the stowed position and the transport position, in other words it is not demounted. In particular, it is advantageous if the transport device is configured and mounted on the superstructure of the vibratory plate compactor such that it is pivoted about the support arm rotation axis relative to the superstructure of the vibratory plate compactor together with the at least one wheel, in particular the pair of wheels, between the stowed position and the transport position during an adjustment between the stowed position and the transport position. The support arm rotation axis denotes a geometric movement axis and preferably extends horizontally and transversely to the forward direction of the vibratory plate compactor.

To ensure that the transport device does not come out of the stowed position in an uncontrolled manner, in particular during operation of the vibratory plate compactor, the transport device comprises a latching device for locking the transport device in the stowed position. Specifically, a latching element may be provided for this purpose, which can be moved from a latching position in the direction of an release region. When located in the release region, the latching element does not lock the transport device in the stowed position. In the latching position, on the other hand, the latching element secures the transport device in the stowed position relative to the superstructure of the vibratory plate compactor. The release region therefore refers to a range within which the latching element can be moved without being in the latching position. The release region may adjoin a release position with respect to the movement of the latching element. The release position refers to the position of the latching element starting from which it is possible to move the transport device from the stowed position in the direction of the transport position past the latching element. Once the latching element continues to move beyond this position, it moves within its release region. The movement range of the latching element within the release region may be limited by an adjustment stop.

The latching element is preferably a latching lever. This lever may be hinged to the superstructure of the vibratory plate compactor via a swivel joint to pivot about a latching element rotation axis. The latching element rotation axis particularly preferably extends parallel to the support arm rotation axis.

According to the invention, the transport device of the vibratory plate compactor comprises a pivot drive gear configured such that it converts an adjustment movement of the latching device, in particular of the latching element, from the latching position towards the release region into a pivot movement of the support arm from the stowed position towards the transport position. This gives the latching device, in particular the latching element, a dual function, because in addition to locking and releasing the transport device, it can be used as a movement transmission element with which at least a movement impulse of the transport device from the stowed position to the transport position can be initiated. The advantage for the operator is that he now only has to actuate a single device, ideally with a single, particularly continuous actuating movement, in order to simultaneously or successively release the latching or locking of the transport device in the stowed position and also to initiate the adjustment movement of the transport device from its stowed position towards the transport position.

The latching device and the pivot drive gear may thus be coupled to each other, in particular mechanically force-coupled. This coupling does not have to be permanent or present in every relative position of the latching device. It may also be provided transitionally and in only certain movement or adjustment phases of the latching device and in particular the latching element. However, it is essential that the latching device and the pivot drive gear are configured with respect to each other such that a joint actuating movement, in particular of the latching element, both releases the locking of the transport device in the stowed position and moves the transport device out of the stowed position towards the transport position.

The pivot drive gear may be configured such that it drives the adjustment movement of the transport device from the stowed position towards the transport position at least up to a movement apex or at least beyond a movement apex towards the transport position, from which the transport device then continues its adjustment movement towards the transport position driven by gravity and thus automatically when the vibratory plate compactor is positioned with the ground-contacting plate resting on the ground surface. Beyond this movement apex, it is also possible that movement-transmitting elements of the pivot drive gear come out of engagement with each other or out of contact with each other.

It has been shown that this type of transport device is particularly suitable for so-called forward-running vibratory plate compactors. Such vibratory plate compactors generally comprise a vibration exciter device, the amplitude of which is inclined forwards at an angle in the upward direction, so that the vibratory plate compactor will move step-wise in a forward direction in a self-propelled manner when bouncing.

The latching element may have a locking stop which, in the stowed position of the transport device, engages with a locking formation connected in a co-rotating manner to the at least one support arm such that a pivoting movement about the support arm rotation axis from the stowed position towards the transport position is blocked. The locking stop may be configured as a latching lug, for example. The locking formation may, for example, be configured as a recess that is at least partially complementary to the locking stop, in particular the latching lug.

It is preferred if the movement direction of the latching element is constant during adjustment from the latching position towards the release region and in particular within the release region. A pivot movement about a latching element rotation axis, in particular about the latching element rotation axis, is particularly preferred. The latching element rotation axis preferably extends parallel to the support arm rotation axis.

It is possible that the locking formation is arranged on a support arm shaft extending in a longitudinal direction of the support arm rotation axis, in particular in a fixed position. The support arm shaft, which can rotate about the support arm rotation axis, not only mounts the support arm(s) of the at least one wheel, in particular the pair of wheels, but in this case also carries the locking formation at the same time. Preferably, when the transport device is adjusted, the locking formation thus also rotates about the support arm rotary shaft and, in particular, out of the engagement range of the latching element.

The locking formation may be part of a control cam with a cam surface extending around the support arm rotation axis. It is preferred if the locking formation is configured as a locking recess that is recessed radially relative to the support arm rotation axis, in particular with a stop surface for the latching element which extends radially relative to the support arm rotation axis. In particular, the cam surface may now be configured such that its radial distance in the direction of rotation increases continuously from the transport position towards the stowed position of the transport device and then decreases abruptly to form the locking recess. In this way, a cam lift region is provided for the return movement of the transport device, which may act as a guide surface for the latching element towards the latching position.

It is advantageous if the latching element is spring-loaded towards its latching position. This can be achieved using a suitable spring device, for example a tension or compression spring. In this way, it can be ensured more reliably that the latching element, in particular when the transport device is returned from the transport position into the stowed position, automatically locks the transport device when the stowed position is reached and the latching element does not have to be moved separately and manually into the latching position, for example.

There are various options with regard to the specific configuration of the pivot drive gear. For example, linkages may be used. However, it has proven to be advantageous if the pivot drive gear is configured as a cam mechanism. Cam mechanisms are characterized by the fact that they comprise a radial cam and a curve-contacting device running along the radial cam, for example a follower. With the help of the follower moving along the radial cam, a movement transmission and/or movement conversion of the elements carrying the follower and the radial cam is achieved.

It is possible, for example, for the cam mechanism to have a radial cam that is fixed relative to the support arm. The radial cam may be configured as an elongated hole extending in the direction of its longitudinal extension. However, it is preferred if the radial cam is configured such that it only has a control surface on one side transverse to its longitudinal extension. The cam mechanism may further include a follower fixed relative to the latching element. The follower may be configured as a protruding finger or also comprise a roller, in particular one with rolling bearings. The follower may thus be mounted on the latching element such that it can rotate. What is essential is that it does not change its mounting position relative to the latching element. Alternatively, the radial cam may also be arranged on the latching element and the follower of the cam mechanism may be arranged on the support arm.

It is particularly advantageous if the follower is a follower pin that protrudes from the latching element in an axial direction of the support arm rotation axis.

A transmission region of the cam mechanism and a contact region of the latching device may be axially spaced in the direction of the support arm rotation axis. The transmission region of the cam mechanism refers to the region of the cam mechanism in which the elements of the cam mechanism, for example the follower and the radial cam, are in contact with each other. The contact region of the latching device refers to the region in which the latching element is in contact with the locking formation, for example.

In practical use, it has proven to be advantageous if the latching element is foot-operated by an operator of the vibratory plate compactor. For this purpose, a foot contact area may be provided on the latching element, which the operator can reach directly with his foot from an ideally standing position to adjust the latching element from the latching position to the release region. Additionally or alternatively, a transmission device may be provided which configured such that an adjustment of the latching element, at least from the latching position into the release region, is triggered manually and transmitted to the latching element by the transmission device. This device may be a Bowden cable, a hydraulic line or the like. A motorized, in particular electromotive, adjustment of the latching element controlled via the transmission device, for example a signal transmission line, is also possible. With the use of a transmission device in particular, it is also possible, for example, to adjust the latching element manually via the hand guide device.

It is possible that a rotary damping device is provided, which is configured such that it damps the adjustment movement of the transport device at least from the stowed position to the transport position. This device may be in the form of or more disk springs, one or more spring washers, one or more gas pressure springs or similar devices. This may prevent the transport device from moving more or less abruptly and with comparatively great force towards the transport position. This is particularly advantageous if the adjustment movement of the transport device is gravity-driven, as described above, especially when a movement apex has been passed. It is ideal if the rotary damping device is configured such that it only has a damping effect beyond a certain movement speed limit and/or a certain angular position. Additionally or alternatively, it is advantageous if the rotary damping device is configured such that it only acts in one direction, specifically the adjustment direction towards the transport position, but not towards the stowed position.

A further aspect of the invention relates to a method for adjusting a transport device of a vibratory plate compactor which can be pivoted between a stowed position and a transport position. The method is particularly suitable for use with a vibratory plate compactor as described above. In this respect, reference is made to the above discussion of preferred embodiments in its entirety also for the method according to the invention.

For the method according to the invention, to adjust the transport device from the stowed position towards the transport position, a first step a) may comprise unlatching a latching device of a support device of the transport device by adjusting a latching element from a latching position towards a release region of the latching element. A step b) may comprise adjusting the transport device from the stowed position towards the transport position using a pivot drive gear. The pivot drive gear ensures that the adjustment of the transport device from the stowed position towards the transport position is at least transitionally defined and guided by the pivot drive gear.

Steps a) and b) can be carried out simultaneously, in parallel or overlapping. However, it is preferred if steps a) and b) are carried out functionally one after the other, with step b) following step a) in particular. It is ideal if a continuation of the adjustment movement of the latching element in step a), for example manually and/or foot-operated or motor-driven, also drives step b).

Step b) may not extend until the transport position of the transport device is actually reached, but may be limited to an initial phase starting from the stowed position with respect to the entire movement process from the stowed position to the transport position. This initial phase may extend, for example, until the transport device reaches a movement apex beyond which the transport device continues to move, for example gravity-driven, towards the transport position.

To initiate step b), a cam mechanism follower may strike a radial cam of the cam mechanism, in particular when the latching element has reached a release position or has passed into a release region.

To adjust the transport device from the transport position towards the stowed position, a step c) may comprise pivoting the support device from the transport position towards the stowed position. During this movement, it is advantageous if a step d) comprises following a cam surface of a control cam and thereby adjusting the latching element radially outwards relative to the support arm rotation axis. It is particularly preferred if a spring load acting on the latching element in the direction of the stowed position is tensioned or further tensioned as a result. Step e) then comprises engaging of the latching element in a latching position, in particular driven by a spring load acting on the latching element, by adjusting a latching formation of the latching element radially inwards when the transport device is in the transport position.

### BRIEF DESCRIPTION OF THE DRAWINGS

The invention will be explained in more detail below by reference to the embodiment examples shown in the figures. In the schematic figures:

FIG. 1 is a top view of a vibratory plate compactor;

FIG. 2 is a cross-sectional view of the vibratory plate compactor of FIG. 1 with the transport device in the stowed position;

FIG. 3 is a cross-sectional view of the vibratory plate compactor of FIG. 1 with the transport device in the transport position;

FIG. 4A shows the transport device of FIGS. 1 to 3 in the stowed position with the latching device in a latching position;

FIG. 4B is a detailed view of the latching device of FIG. 4A;

FIG. 5A shows the transport device of FIGS. 1 to 3 in the stowed position with the latching device in a release position;

FIG. 5B is a detailed view of the latching device of FIG. 5A;

FIG. 6A shows the transport device of FIGS. 1 to 3 in a transition position between the stowed position and a transport position with the latching element located in the release region;

FIG. 6B is a detailed view of the latching device of FIG. 6A;

FIG. 7A shows the transport device of FIGS. 1 to 3 in a transport position with the latching element resting on a control cam;

FIG. 7B is a detailed view of the latching device of FIG. 7A; and

FIG. 8 is a flow chart of a method according to the invention.

### DETAILED DESCRIPTION

Like parts or functionally like parts are designated by like reference numerals in the figures. Recurring parts are not necessarily designated separately in each figure.

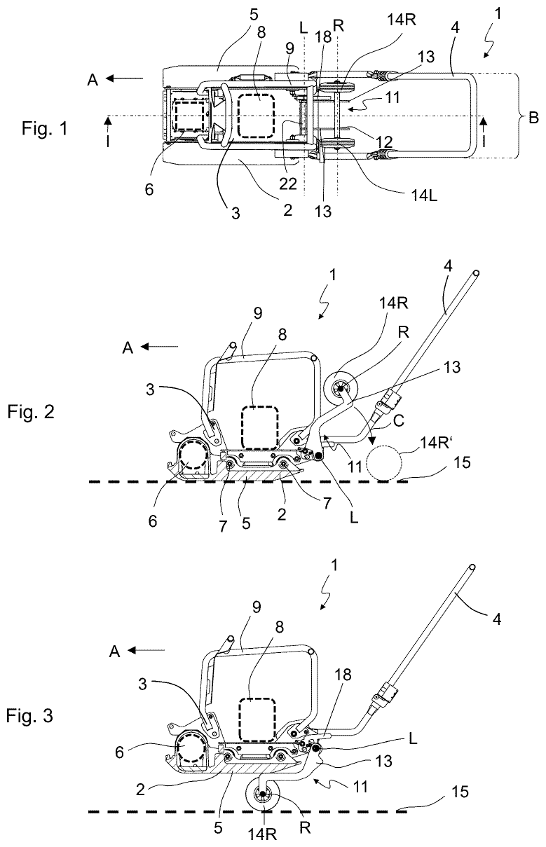

FIG. 1 shows a top view of a vibratory plate compactor 1, and FIG. 2 shows a cross-sectional side view of this vibratory plate compactor 1 along line I-I of FIG. 1.

The vibratory plate compactor 1 may comprise a substructure 2, a superstructure 3 and a hand guide device 4. The substructure 2 may have a ground-contacting plate 5, which is angled and/or bent upwards to the front and rear sides when viewed in the forward direction A. One or more vibration exciter devices 6, in particular imbalance exciters, may be arranged on the ground-contacting plate 5. These imbalance exciters each have a drive motor, for example a hydraulic or electric motor, or be connected by a drive train to a drive device, for example a drive motor arranged on the superstructure, in particular a combustion engine or electric motor. The drive train may have a belt drive or similar for this purpose. In the exemplary vibratory plate compactor 1 shown in FIGS. 1 and 2, the vibration exciter device is arranged in a front third of the longitudinal extension of the substructure when viewed in forward direction A.

The superstructure 3 is arranged vertically above the substructure 2 and may be connected to the substructure 2 via damping devices 7 (FIG. 2), for example rubber buffers or rubber mounts. The superstructure 3 may be a frame-like support structure on which one or more functional components 8 may be arranged. Such functional components may be, for example, a drive motor and/or one or more energy storage devices, in particular accumulators or a fuel tank, operating fluid tanks, such as a water and/or oil tank, one or more control devices, for example power electronics, or similar. The superstructure 3 may also have a protective structure, for example a protective cage 9 or a protective hood or other mechanical protective devices to protect the functional components 8.

The hand guide device 4 may be connected to the superstructure 3 of the vibratory plate compactor 1 via damping supports 10, in particular in a rear third of the longitudinal extension of the superstructure 3 in the forward direction A. The hand guide device 4 may be configured as a guide drawbar or, as shown in FIGS. 1 and 2, as an essentially U-shaped guide bracket, which is articulated with its two longitudinal leg ends to the superstructure 3 of the vibratory plate compactor 1 via the damping supports 10. The hand guide device 4 may be pivotable relative to the superstructure 3 about a pivot axis, in particular horizontal and transverse to the forward direction A. The hand guide device 4 can preferably be locked or fixed relative to the superstructure 3 by means of a suitable locking device (not shown in the figures).

The vibratory plate compactor 1 may have a transport device 11. The transport device may be adjustable between a stowed position, as shown in FIG. 2, and a transport position, as shown in FIG. 3. The transport device 11 may have a support device 12, in particular comprising one or more support arms 13, and at least one wheel, in particular a pair of wheels 14. It is advantageous if there is at least one wheel per support arm 13. Instead of the pair of wheels 14, only one wheel, for example in the form of a roller, may thus be provided. The wheels 14 may be rotatable about a common wheel rotation axis R, which in particular extends horizontally and transversely to the forward direction A. In this respect, a right-hand wheel 14R seen in the forward direction A and a left-hand wheel 14L seen in the forward direction A may be provided and form the wheel pair 14. The transport device 11 may also include other wheels.

In the stowed position, the pair of wheels 14 is raised relative to the underlying ground 15. For example, it may be locked in a position relative to the superstructure 3 in which both the wheels and the support arms 13, in a plan view of the vibratory plate compactor, lie between the two longitudinal legs of the hand guide device 4, which is configured as a hand guide bracket, for example, and/or within the maximum width B of the hand guide device in a virtual horizontal reference plane. The transport device 11 is locked in the stowed position by means of a latching device described in more detail below.

From the stowed position shown in FIGS. 1 and 2, the transport device 11 can be pivoted about a support arm rotation axis L into the transport position shown in FIG. 3. In the present embodiment example, the support arm rotation axis L is parallel to the wheel rotation axis R. During the pivoting movement of the transport device 11 about the support arm rotation axis L, the wheels 14 are thus pivoted in the pivoting direction C relative to the superstructure 3.

FIG. 3 shows a final transport position. Starting from the stowed position shown in FIGS. 1 and 2, the transport device 11 can be adjusted in several successive phases. In particular, the transport device 11 may first be unlocked in the stowed position, as shown in more detail in the following figures. From this point, the transport device 11 may first pivot in the direction of arrow C, in some cases also gravity-driven, to an intermediate position in which the wheels 14 rest on the underlying ground 15, for example in the forward direction A behind the superstructure in the present embodiment example, as indicated by 14R′ in FIG. 2. In this position, the vibratory plate compactor can then be raised at the rear, for example by pushing up the hand guide device 4 in the forward direction A, so that the wheels 14 can pivot to underneath the underside of the ground-contacting plate and the components substructure 2, superstructure 3 and hand guide 4 can be jacked up on the support arms 13, which are at least partially L-shaped, for example. The transport device 11 is then in the transport position and the vibratory plate compactor 1 rests on the underlying ground 15 via the wheels 14 so that it can be moved more easily over the underlying ground, particularly for transportation purposes.

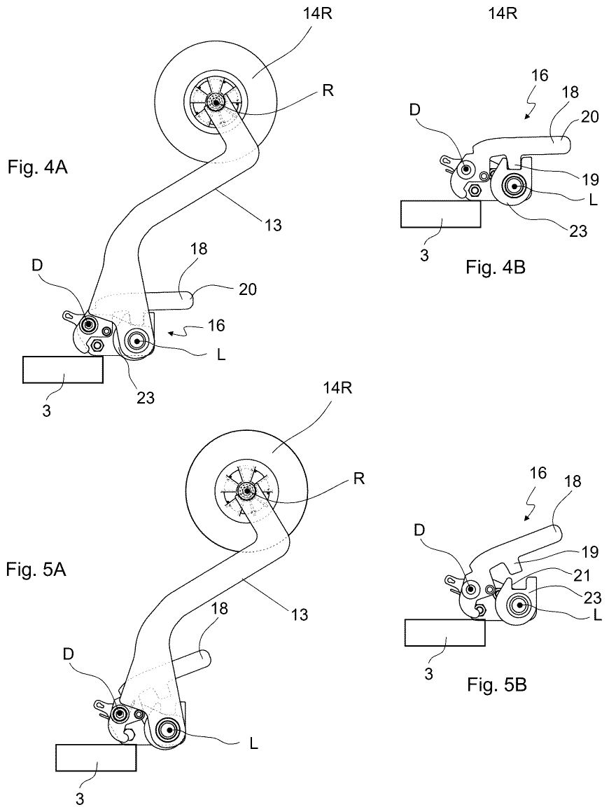

FIGS. 4A to 7B illustrate the structure and mode of operation of a latching device 16 and a pivot drive gear 17 (FIG. 5A), which influence the the adjustment process described in FIGS. 2 and 3. In each of the figures marked “A”, a support arm 13 is shown from the perspective corresponding to FIGS. 2 and 3 with further elements described below. In the figures marked “B”, the support arm 13 and the wheel 14R are hidden. The section visible there shows an enlarged view of the latching device 16. The transport device 11 is illustratively hinged to the upper mass 3, which is shown in FIGS. 4A to 7B in a highly schematic form for reasons of clarity. FIGS. 4A and 4B correspond to the vibratory plate compactor of FIG. 2 with the transport device 11 in the stowed position. FIGS. 7A and 7B correspond to the vibratory plate compactor of FIG. 3 with the transport device 11 in the transport position.

The latching device 16 comprises a latching element 18 configured as a latching lever. The latching element is rotatable about a latching element rotation axis D, specifically from the latching position shown in FIGS. 4A and 4B towards a release region. The latching element 18 may have a locking stop 19 projecting at least partially in the direction of a rotary movement about the latching element rotation axis D. There may also be an actuating projection 20 projecting radially relative to the latching element rotation axis D. The actuating projection may adjoin a region of the latching lever carrying the locking element 19 radially on the outside relative to the latching element rotation axis D. It is ideal if the actuating projection extends against the forward direction A to above the rear edge of the substructure 2 and/or to above the support arm rotation axis L and protrudes at least partially horizontally beyond them to the rear, for example to be easily accessible for the foot of an operator.

A locking formation 21 is also part of the latching device 16 (FIG. 5B). The latching formation has a control cam 23 arranged on a support arm shaft 22 (FIG. 1) extending along the support arm rotation axis L. The control cam 23 is fixed to the support arm shaft 22 and thus also fixed relative to the support arms 13, so that it co-rotates about the support arm rotation axis L when the transport device 11 is pivoted relative to the superstructure 3. The control cam 23 comprises a recess 25 which is set back radially inwards towards the support arm rotation axis L relative to a cam surface 24 (FIG. 7B) extending on the outer circumference of the control cam 23 around the support arm rotation axis L and which may be formed at least partially in the direction of rotation around the support arm rotation axis L in a positive fitting manner with respect to a corresponding contact region on the locking stop 19. In the latching position, the latching element 18 engages in this recess 25 when the transport device is in the transport position and the control cam 23 is in the corresponding rotational position, thereby positively locking a rotary movement of the transport device 11 about the support arm rotation axis L.

The latching element 18 may be spring-loaded towards the latching position with a suitable tension or compression spring device 26 (FIG. 4B), as in FIGS. 4A and 4B.

The pivot drive gear 17 may have a radial cam 27 and a follower 28. The radial cam 27 may be part of the support arm 13. The follower 28 may be arranged on the latching element 18. It may be configured as a pin projecting in particular in the axial direction of the support arm rotation axis L or also as a roller, in particular with rolling bearings. A reverse arrangement of these elements of the pivot gear 17 is also possible. The follower 28 and the radial cam 27 are positioned relative to one another such that they come into contact with one another when the latching element 18 is moved out of the stowed position at least when the transport device 11 is in the transport position. In other words, they are at least partially at a same level in an axial direction of the support arm rotation axis L, just like the locking stop 19 and the locking formation 21, and therefore strike against each other during the adjustment movement. This process is explained in more detail below with reference to FIGS. 4A to 7B.

In the positioning as shown in FIGS. 2, 4A and 4B, the latching element 18 located in the latching position locks an adjustment of the transport device 11 located in the stowed position towards the transport position in the direction of arrow C about the support arm rotation axis L. An operator may now move the latching element 18 about the latching element rotation axis D in the direction of arrow E towards the release region, for example with a foot, a hand or using a transmission device not shown in detail in the figures, such as a Bowden cable or the like attached to the latching element 18. Motorized adjustment of the latching element 18 is also possible. As a result, the locking stop 19 is disengaged from the locking formation 21 and then reaches its release position once it has been lifted out of the recess 25 of the locking formation 21 in radial direction relative to the support arm rotation axis L to such an extent that the cam surface 24 can pass by underneath it during a rotary movement of the of the control cam 23.

Once the latching element 18 has been lifted out of the locking formation 21 at least as far as to the release position towards the release region about the latching element rotation axis D, the follower 28 strikes against the radial cam 27. When the adjustment movement of the latching element 18 continues in the direction of arrow E, the follower 28 moves along the radial cam 27 and pushes the support arm 13 in the direction of arrow C from the stowed position of the transport device 11 towards the transport position.

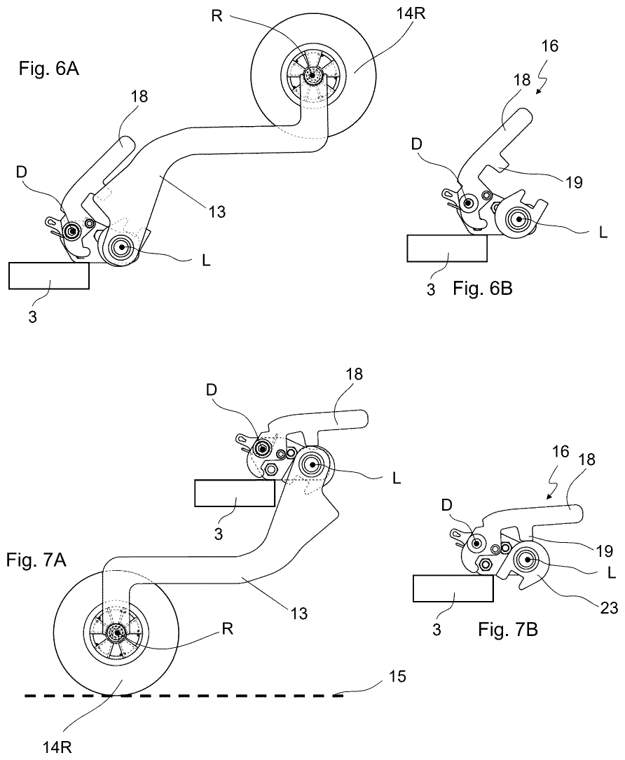

Beyond a certain tilted position of the support arm 13, in particular if the pivot movement of the support arm 13 continues automatically towards the transport position driven by gravity, it is possible that the follower 28 lifts off the radial cam 27, so that from this point there is no longer any gear engagement and the individual elements of the pivot drive gear 17 no longer fulfill a gear function. This is the case, for example, in FIGS. 6A and 6B. The contact region between the follower 28 and the radial cam 27 is also referred to as the transmission region 29 of the cam mechanism and is illustratively marked in FIG. 7A. In order to control a “falling down” of the transport device, a rotary damping device 30 (FIG. 5A) may be provided, for example in the form of a gas pressure spring or the like.

In order to bring the transport device 11 into the final transport position, as shown in FIGS. 7A and 7B, the vibratory plate compactor 1 may be pivoted upwards from behind in the forward direction A, so that the supports arms 13 with the wheels 14 can pivot to underneath the underside of the ground-contacting plate 5. The vibratory plate compactor can then be jacked up on the support arms 13 such that it rests with the wheels 14 on the underlying ground 15.

It is possible, but not absolutely necessary, to also lock the transport device 11 in the transport position 11. For this purpose, for example, a further recess may be provided on the control cam 23. In the present embodiment example, however, the transport device 11 is not locked in the transport position. However, the spring-loaded latching element 18 is pressed onto the cam surface 24 with its locking stop 19. If the transport device 11 is pivoted from the transport position towards the stowed position about the support arm rotation axis L, the cam surface 24 rotating under the locking stop 19 pushes the latching element 18, or the locking stop 19 of the latching element 18, radially outwards relative to the support arm rotation axis L. If the rotary movement is continued towards the stowed position, the locking stop 19 can then snap automatically into the locking formation 21 or the recess 25, driven by the tension or compression spring device 26.

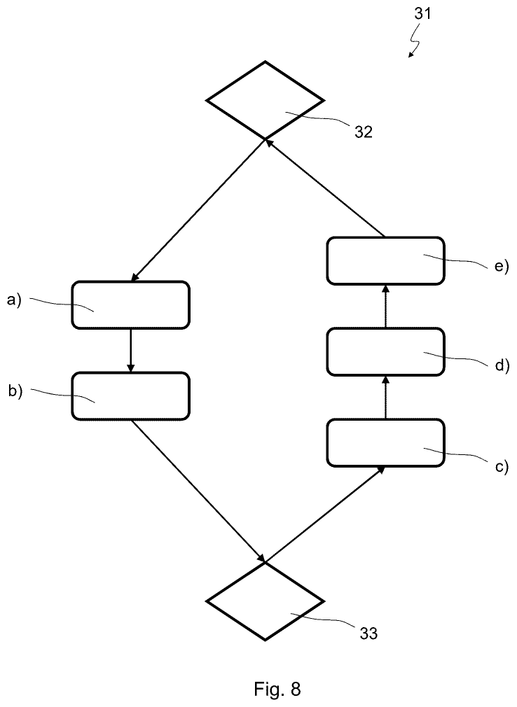

FIG. 8 illustrates the sequence of a method 31 for adjusting a transport device 11 of a vibratory plate compactor 1 between a stowed position 32 and a transport position 33, in particular as described above, especially for a vibratory plate compactor 1 as described above.

To perform adjusting 34 from the stowed position 32 towards the transport position 33, the method may comprise unlatching a) a latching device 16 of a support device 12 of the transport device 11 by adjusting a latching element 18 from a latching position towards a release region and adjusting b) the transport device 11 from the stowed position 32 towards the transport position 33 with the aid of a pivot drive gear 17. Steps a) and b) may be carried out functionally one after the other, in particular such that a continuation of the adjustment movement of the latching element, in particular in the same direction of movement, in step a) drives step b). This can be done at the same time as step a) and/or temporally overlapping.

For adjusting 35 from the transport position 33 towards the stowed position 32, the method may comprise pivoting c) the support device 12 from the transport position 33 towards the stowed position 32, following d) a cam surface 24 of a control cam 23 and thereby adjusting the latching element 18 radially outwards relative to the support arm rotation axis L and, finally, engaging e) of the latching element 18 in a latching position, in particular driven by spring force, by adjusting a latching formation or a locking stop 19 of the latching element 18 radially inwards relative to the support arm rotation axis L.

### LIST OF REFERENCE NUMERALS

1 vibratory plate compactor
2 substructure
3 superstructure
4 hand guide device
5 ground contacting plate
6 vibration exciter device
7 damping device
8 functional devices
9 protective cage
10 damping support
11 transport device
12 support device
13 support arm
14 wheel
14L left wheel
14R right wheel
15 underlying ground
16 latching device
17 pivot drive gear
18 latching element (latching lever)
19 locking stop
20 actuating projection
21 locking formation
22 support arm shaft
23 control cam
24 cam surface
25 recess
26 tension or compression spring device
27 radial cam
28 follower
29 transmission region
30 rotary damping device
31 method
32 stowed position
33 transport position
34 adjusting from the stowed position towards the transport position
35 adjusting from the transport position towards the stowed position
A forward direction
B width
C pivoting direction towards the transport position
D latching element rotation axis
E direction of movement into the release region
L support arm rotation axis
R wheel rotation axis
a) unlatching
b) adjusting
c) pivoting
d) following
e) engaging

What is claimed is:

1. A vibratory plate compactor, comprising:
a substructure with a ground-contacting plate;
a superstructure connected to the substructure via a damping device with one or more functional devices;
a hand guide device and a transport device mounted on the superstructure such that it can pivot about a support arm rotation axis between a stowed position and a transport position;
the transport device comprising
a wheel arranged on a support device with at least one support arm, the at least one support arm being pivotable about the support arm rotation axis relative to the superstructure of the vibratory plate compactor between the stowed position and the transport position;
a latching device for locking the transport device in the stowed position with a latching element adjustable from a latching position towards a release region; and
a pivot drive gear configured such that it converts an adjustment movement of the latching device into a pivot movement of the support arm from the stowed position towards the transport position.

2. The vibratory plate compactor according to claim 1, wherein the latching element has a locking stop which, in the stowed position of the transport device, engages with a locking formation connected in a co-rotating manner to the at least one support arm such that a pivoting movement about the support arm rotation axis from the stowed position towards the transport position is blocked.

3. The vibratory plate compactor according to claim 2, wherein the locking formation is arranged on a support arm shaft extending in a longitudinal direction of the support arm rotation axis.

4. The vibratory plate compactor according to claim 2, wherein the locking formation is part of a control cam with a cam surface extending around the support arm rotation axis.

5. The vibratory plate compactor according to claim 1, wherein the latching element is spring-loaded towards its latching position.

6. The vibratory plate compactor according to claim 1, wherein the pivot drive gear is configured as a cam mechanism.

7. The vibratory plate compactor according to claim 6, wherein the pivot drive gear comprises a radial cam fixed relative to the support arm and a follower fixed relative to the latching element.

8. The vibratory plate compactor according to claim 7, wherein the follower is a follower pin which projects from the latching element in an axial direction of the support arm rotation axis.

9. The vibratory plate compactor according to claim 6, wherein a transmission region of the cam mechanism and a contact region of the latching device are axially spaced in a direction of the support arm rotation axis.

10. The vibratory plate compactor according to claim 1, wherein the latching element can be actuated by foot and/or manually with the aid of a transmission device, in particular via the hand guide device.

11. The vibratory plate compactor according to claim 1, wherein a rotary damping device is provided, which is configured such that it damps the adjustment movement of the transport device at least from the stowed position to the transport position.

12. A method for adjusting a transport device of a vibratory plate compactor according to claim 1, which can be pivoted between a stowed position and a transport position, comprising, for adjusting from the stowed position towards the transport position, the steps of:
a) unlatching a latching device of a support device of the transport device by adjusting a latching element from a latching position towards a release region;
b) adjusting the transport device from the stowed position towards the transport position using a pivot drive gear.

13. The method according to claim 12, wherein steps a) and b) are carried out functionally one after the other, in particular such that a continuation of the adjustment movement of the latching element in step a) drives step b).

14. The method according to claim 13, wherein to initiate step b), a follower of a cam mechanism strikes against a radial cam of the cam mechanism.

15. The method according to claim 12, comprising, for adjusting from the transport position towards the stowed position, the steps of:
c) pivoting the support device out of the transport position towards the stowed position;
d) following a cam surface of a control cam and thereby adjusting the latching element radially outwards relative to the support arm rotation axis;
e) engaging the latching element in a latching position by adjusting a latching formation of the latching element radially inwards relative to the support arm rotation axis.
